(19) United States
(12) Patent Application Publication
(10) Pub. No.: US 2016/0144927 A1
(43) Pub. Date: May 26, 2016

(54) Scooter Generating Power By Rowing In Both Directions

(71) Applicants: Christopher John Bayne, Los Gatos, CA (US); Steven Barker, Sheridan, OR (US)

(72) Inventors: Christopher John Bayne, Los Gatos, CA (US); Steven Barker, Sheridan, OR (US)

(73) Assignee: ROTA MOBILITY, INC., Los Gatos, CA (US)

(21) Appl. No.: 14/890,767

(22) PCT Filed: Mar. 17, 2014
(86) PCT No.: PCT/US2014/030803

§ 371 Date: Nov. 12, 2015

Related U.S. Application Data
(60) Provisional application No. 61/801,293, filed on Mar. 15, 2013.
(60) Provisional application No. 61/873,926, filed on Sep. 5, 2013.

(51) Int. Cl. B62M 1/16; B62L 1/00; B62M 9/06

(52) U.S. Cl. CPC B62M 1/16; B62M 9/06; B62L 1/00

(57) ABSTRACT

Disclosed herein is a scooter-type vehicle comprising at least one front wheel and at least two rear wheels, wherein power for forward motion is developed by the occupant of the vehicle pushing and pulling a propulsion lever, which also serves as the steering mechanism for the vehicle, in both directions. A novel inventive gearbox mechanism is contained in a small housing, which allows for the drive wheel, through the steering means, to be rotated fully 180 degrees, allowing backward motion of the vehicle as well.

### REFERENCE TO PRIORITY DOCUMENTS

This application claims priority under 35 USC §119(e) to U.S. provisional application Ser. Nos. 61/801,293, filed Mar. 15, 2013, and 61/873,926, filed Sep. 5, 2013.

### BACKGROUND OF THE INVENTION

Although the field of occupant-propelled vehicles is well-developed, there remains a need for an occupant-propelled scooter-type vehicle in which the power for forward motion of the vehicle is generated from a rowing motion, in both directions. The present invention accomplishes that goal.

### SUMMARY OF THE INVENTION

The inventive scooter-type vehicle will be equipped with at least one front wheel and at least two rear wheels, and further comprises a propulsion/drive system operated by the occupant of the vehicle, wherein power for forward motion of the vehicle is developed by pushing and pulling a propulsion lever, in both directions, said propulsion lever being functionally connected through an integral transmission/gearbox mechanism in which opposing contra rotational clutches allow the occupant to develop said power for forward motion by both pulling and pushing actions of the propulsion lever, to the at least one front wheel, for delivering power developed by action of the propulsion lever to the ground, for forward motion of the scooter-type vehicle, wherein said integral transmission/gearbox mechanism is contained in a rotatable module, allowing the at least one front wheel to be rotated 180 degrees, thereby permitting backward motion of the scooter-type vehicle.

The present invention affords a scooter-type vehicle wherein the power for forward motion is developed by a rowing motion, through a lever which is also employed for steering the vehicle, in both forward and backward directions. Steering of the vehicle is effected by operation of the propulsion lever as well.

The centerpiece of the present invention is a novel, integral and compact drive-train/transmission mechanism developed by the inventors. The rowing motion whereby the vehicle is propelled reduces the incidence of repetitive stress injuries, like carpal tunnel syndrome, in the user, as compared with traditional hand-rim driven wheelchairs. Furthermore, use of the scooter-type vehicle according to the present invention affords good cardiovascular exercise, benefitting the physical health of the user. It is particularly useful for persons who have motor impairments of the lower body (i.e., the legs), but can be used by anyone, regardless of physical impairment.

Regardless of pushing or pulling the propulsion lever, the motion results in uni-directional movement of the drive (front) wheel through the use of opposing one-way clutches. Because the propulsion/drive mechanism is so compact, and is contained in a small housing at the front of the vehicle, the front (drive) wheel may be rotated 180 degrees, allowing the propulsion lever to drive the vehicle in a reverse direction.

### BRIEF DESCRIPTION OF THE DRAWINGS

FIG. 1A is an embodiment of the scooter as seen from the side;

FIG. 1B is a view of the scooter as seen from the rear;

FIG. 1C is a view of the scooter as seen from the underside;

FIG. 1D is a view of the scooter as seen from the front;

FIG. 1E is a view of the scooter as seen from the top;

FIG. 2A is a view of the propulsion/drive system;

FIG. 2B is another view of the propulsion/drive system;

FIG. 2C is a view of the propulsion/drive system as seen from the underside;

FIG. 3 is a detailed diagram of the propulsion/drive system, in which the transmission configuration can clearly be seen.

### DETAILED DESCRIPTION OF THE DRAWINGS

The scooter embodiment of the present invention generally operates similarly to those shown in parent application Ser. No. 13/263,683. Power is generated from both the forward and backward movement of the propulsion lever. However, in the present embodiment, a system of gears (ROTA SCOOTER) and chains generates power in a more compact, integral transmission box, which is directed to the front wheel, which “pulls” the vehicle in a forward motion.

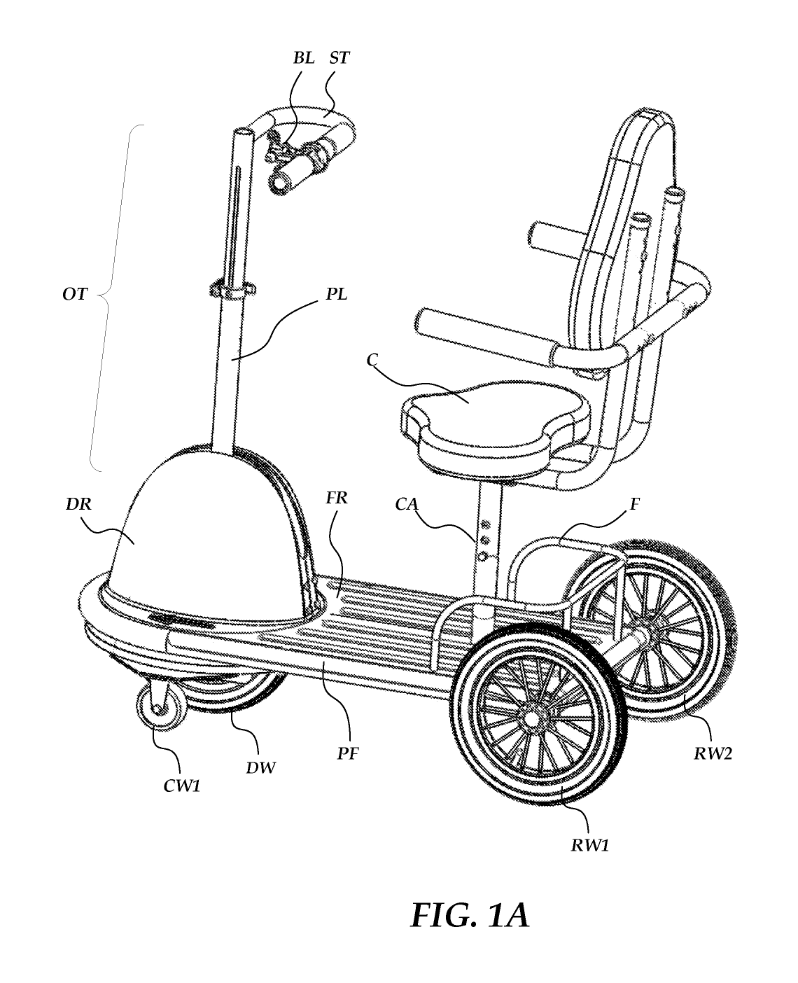

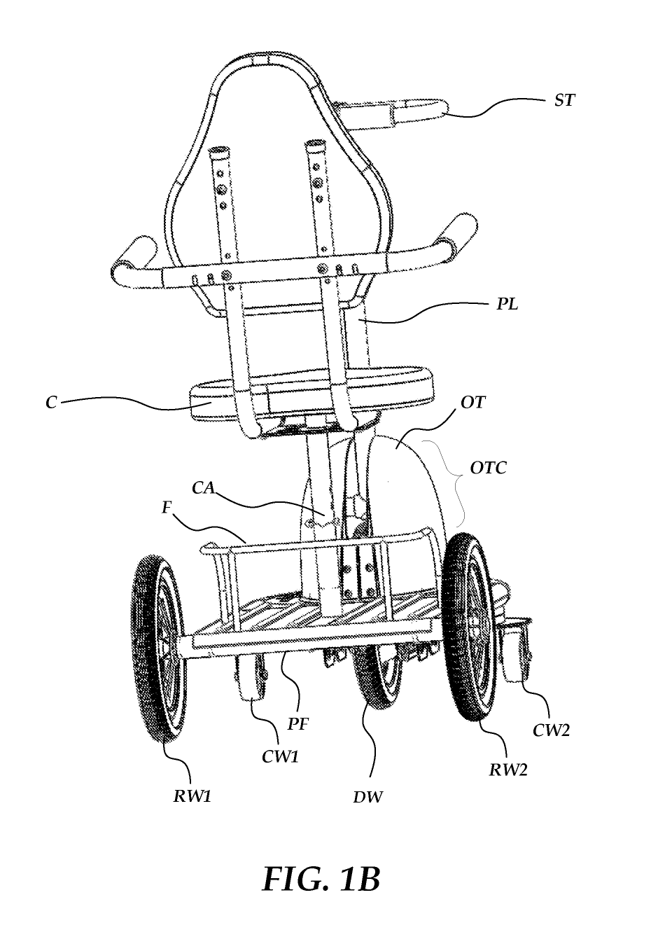

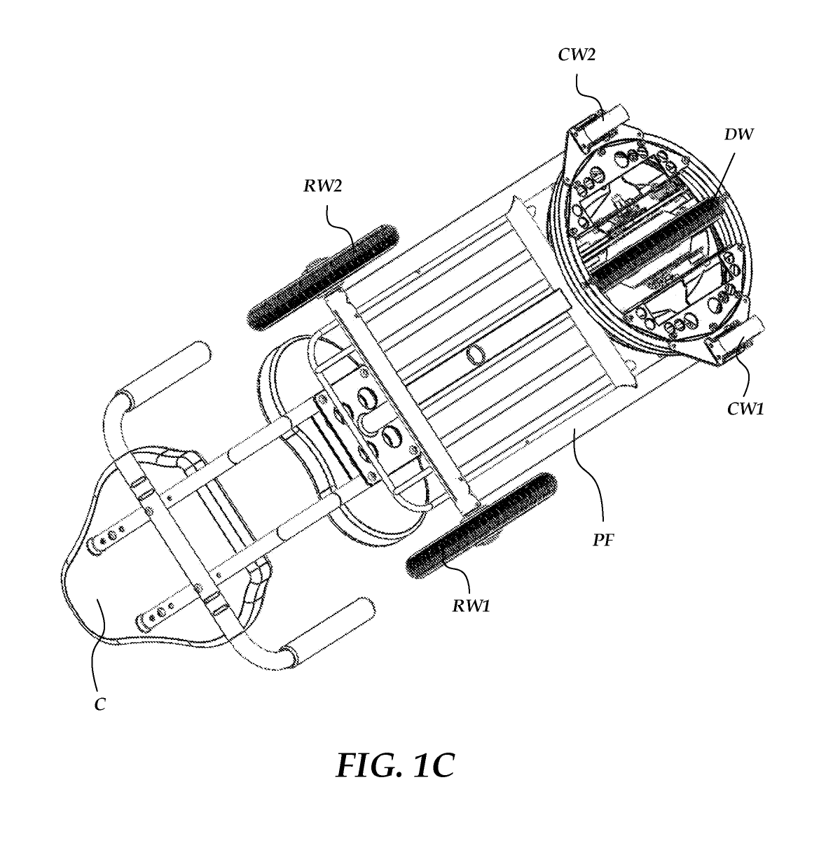

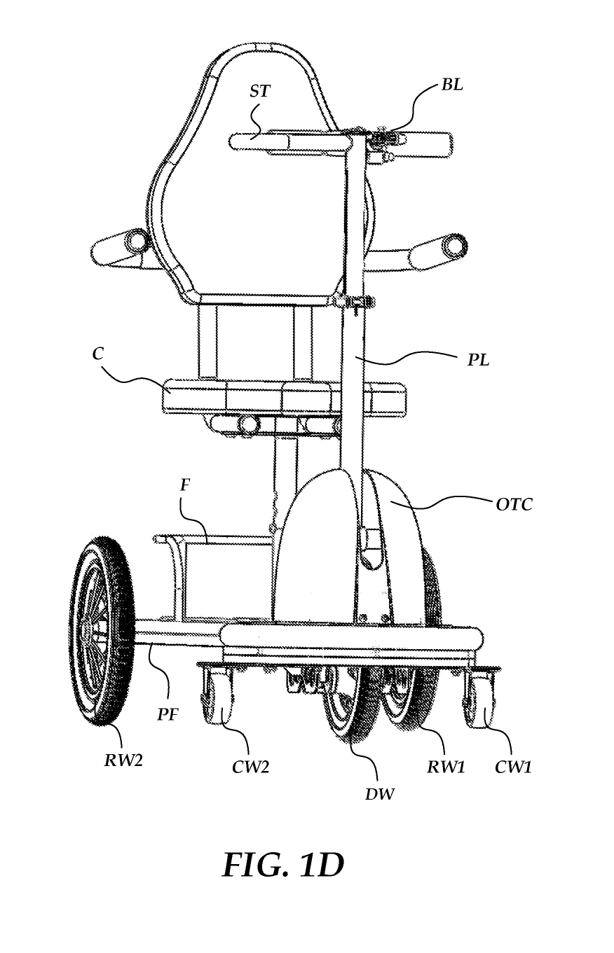

In FIG. 1A, which is a view of the scooter-type vehicle as seen from the side DT denotes the “drive train,” which includes the transmission gear box and propulsion lever (denoted as PL), ST denotes the steering handle, BL denotes the brake lever, DR denotes the transmission gear box, FR denotes the footrest for the occupant, DW denotes the drive wheel, through which power is delivered, PF denotes the platform on the bottom of the vehicle, C denotes the seat for the occupant, CA denotes the seat adjustment knob, F denotes a rack for storing items to be carried on the vehicle, RW1 and RW 2 denote the rear wheels, CW1, CW2 and CW4 denote the front and rear caster wheels on the front and rear of the vehicle for added stability (CW3 is not shown in the diagram).

In FIG. 1B, which is a view of the scooter-type vehicle as seen from the rear, C denotes the seat for the occupant, CA denotes the seat adjustment knob, ST denotes the steering handle, PL denotes the propulsion lever, DT denotes the drive train, DTC denotes the propulsion/drive system housing, F denotes a rack for storing items to be carried on the vehicle, PF denotes the platform on the bottom of the vehicle, RW1 and RW2 denote the rear wheels, CW1, CW2, CW3 and CW4 denote the front and rear caster wheels on the front and rear of the vehicle for added stability.

In FIG. 1C, which is a view of the scooter-type vehicle as seen from the underside, C denotes the seat for the occupant, ST denotes the steering handle, BL denotes the brake lever, PF denotes the platform on the bottom of the vehicle, DW denotes the drive wheel, RW1 and RW2 denote the rear wheels, CW1, CW2, CW3 and CW4 denote the front and rear caster wheels on the front and rear of the vehicle for added stability.

In FIG. 1D, which is a view of the scooter-type vehicle as seen from the front, BL denotes the brake lever, ST denotes the steering handle, PL denotes the propulsion lever, C denotes the seat for the occupant, F denotes a rack for storing items to be carried on the vehicle, PF denotes the platform on the bottom of the vehicle, DTC denotes the propulsion/drive system housing, DW denotes the drive (front) wheel, RW1 and RW2 denote the rear wheels, CW1, CW2, and CW3 denote front and rear the caster wheels for added stability (CW4 is not shown in the diagram).

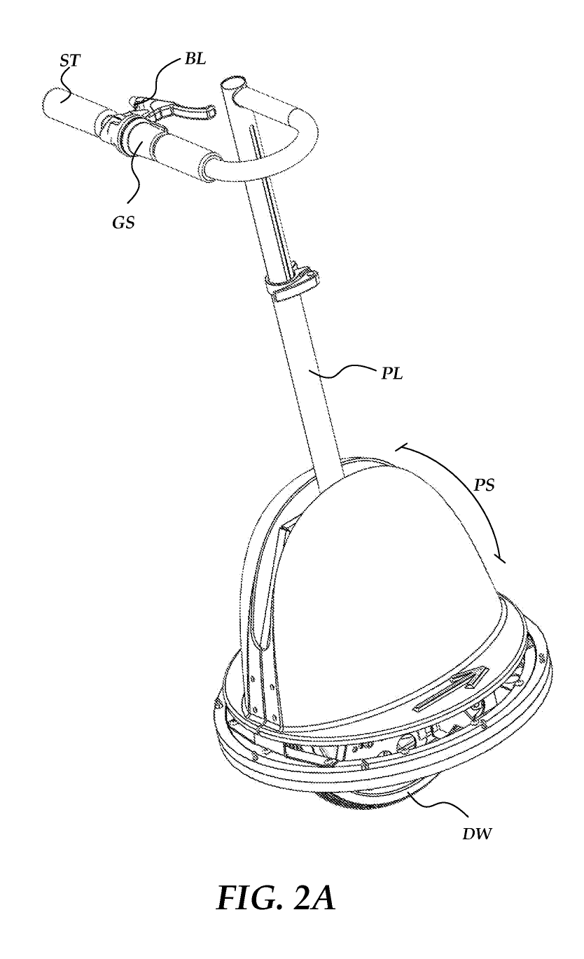

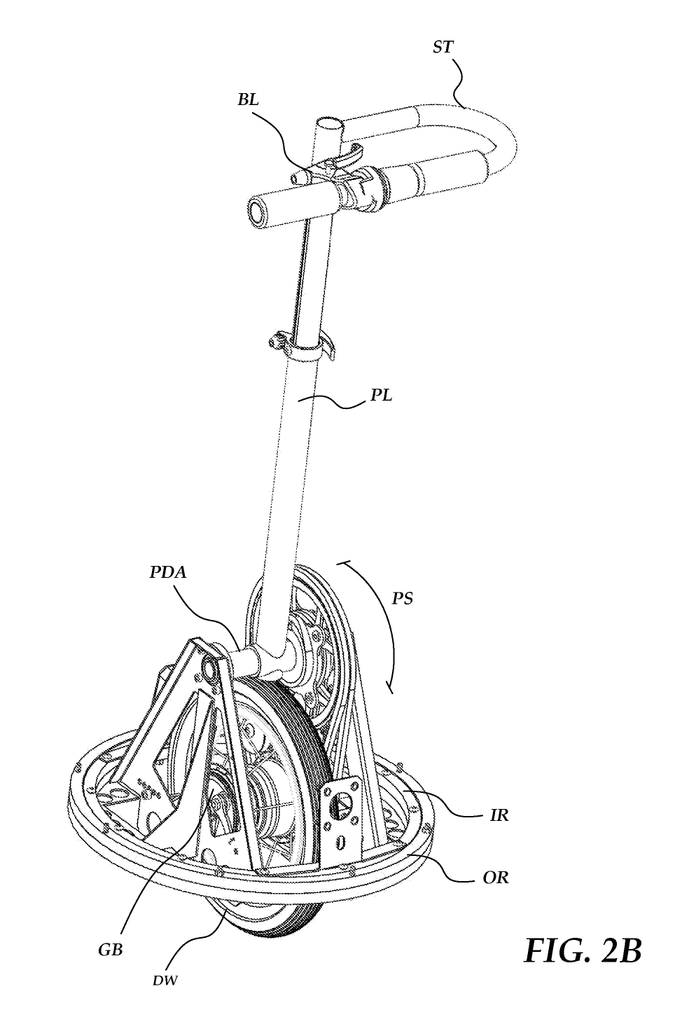

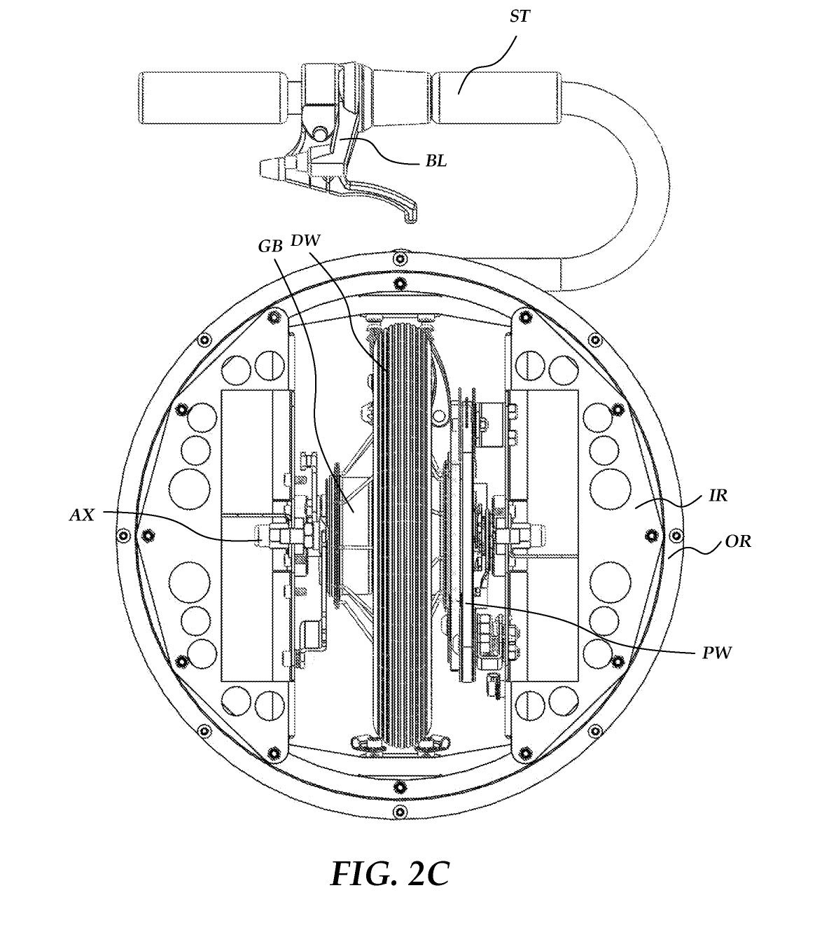

In FIG. 2A, which is a view of the propulsion/drive system, BL denotes the brake lever, GS denotes the gear shifter, ST denotes the steering handle, PL denotes the propulsion lever, PS denotes the power gears, and DW denotes the drive (front) wheel.

In FIG. 2B, which is a view of the propulsion/drive system as seen from the rear, BL denotes the brake lever, ST denotes the steering handle, PL denotes the propulsion lever, PS denotes the power gears, PDA denotes the propulsion lever axle, IR denotes the inner ring of the interface of the propulsion/drive system with the bottom platform of the vehicle, OR denotes the outer ring of the interface of the propulsion/drive system with the bottom platform of the vehicle, DW denotes the drive (front) wheel, GB denotes the gearbox.

In FIG. 2C, which is a view of the propulsion/drive system as seen from the underside, BL denotes the brake lever, ST denotes the steering handle, IR denotes the inner ring of the interface of the propulsion/drive system with the bottom platform of the vehicle, OR denotes the outer ring of the interface of the propulsion/drive system with the bottom platform of the vehicle, PW denotes the power gear, DW denotes the drive (front) wheel, AX denotes the front axle, GB denotes the gearbox.

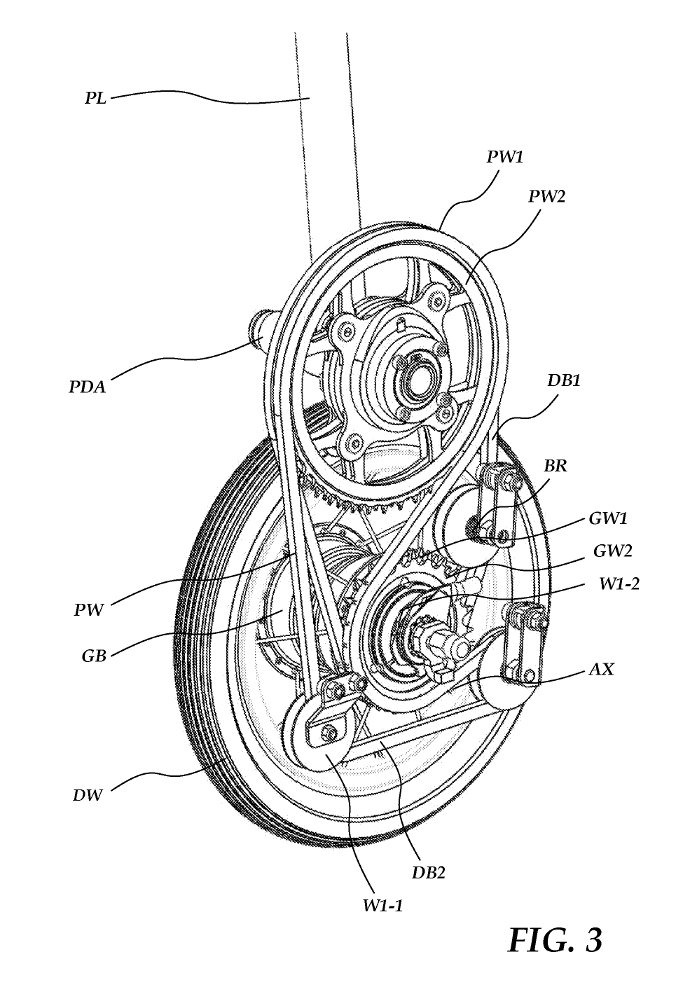

In FIG. 3, which is a detailed diagram of the propulsion/drive system, the propulsion lever (PL) moves in the forward direction, which drives power gear 1 PW1, in the forward direction, while the power gear 2 (PW2) simply does not move, like a bicycle pedaling backwards. Drive belt 1 (DB1) is driven by PW1, so that it moves gear wheel 1 (GW1), which is connected to the gearbox (GB) and the axle (AX). When the propulsion lever (PL) moves in the reverse direction (towards the occupant of the vehicle), power gear 2 (PW2) moves back and drives drive belt 2 (DB2), while PW1 does not move. Drive belt 2 (DB2) changes direction through a series of two gear wheels (W1-1 and W1-2), thus moving drive belt 2 (DB2) forwards when it meets gear wheel 2 (GW2). GW2 is also connected to the gearbox and axle. The net result is that drive wheel (DW) moves in one direction regardless of whether the propulsion lever (PL) is moved forward or backward (toward or away from the occupant of the vehicle). PDA in FIG. 3 denotes the propulsion lever axle, while BR denotes the brake mechanism.

The scooter-type vehicle described herein is modifiable and adaptable in divers ways, which will be obvious to one of ordinary skill in the mechanical arts, without any undue experimentation. For example, rubber belts or linked chains fabricated of metal may be employed in the propulsion/drive system, the wheels may be afforded with pneumatic tires, or solid rubber tires, the frame may be manufactured with different combinations of a variety of materials, such as different metallic alloys, fiberglass, or carbon fiber/epoxy materials, for varying degrees of lightness and strength trade-offs, the seat may be cushioned or not, the brake mechanism may be of the caliper-, disc- or drum-type, and differing degrees of mechanical advantage may be incorporated into the adjustable gearbox.

The drawings contained in this specification represent depictions of the most preferred embodiment of the present invention, but are not intended to limit the inventive scooter-type vehicle to any particular configuration. For example, although the preferred embodiment of the present invention is one where one drive (front) wheel is outfitted to the vehicle, an embodiment wherein two drive (front) wheels will readily be envisioned by one of ordinary skill in the mechanical arts.

We claim:

1. A scooter-type vehicle having at least one front wheel and at least two rear wheels, comprising a propulsion/drive system operated by the occupant of the vehicle, wherein power for forward motion of the vehicle is developed by pushing and pulling a propulsion lever, in both directions, said propulsion lever being functionally connected through an integral transmission/gearbox mechanism in which opposing contra rotational clutches allow the occupant to develop said power for forward motion by both pulling and pushing actions of the propulsion lever, to the at least one front wheel, for delivering power developed by action of the propulsion lever to the ground, for forward motion of the scooter-type vehicle, wherein said integral transmission/gearbox mechanism is contained in a rotatable module, allowing the at least one front wheel to be rotated 180 degrees, thereby permitting backward motion of the scooter-type vehicle.

2. The scooter-type vehicle according to claim 1, wherein the transmission/gearbox mechanism is outfitted with variable gears, adjustable by the occupant of the vehicle.

3. The scooter-type vehicle according to claim 1, wherein the transmission/gearbox mechanism is outfitted with linked metal drive chains connecting the gears to one another.

4. The scooter-type vehicle according to claim 1, wherein the transmission/gearbox mechanism is outfitted with rubber belts connecting the gears to one another.

5. The scooter-type vehicle according to claim 1, wherein the vehicle is equipped with a caliper-type braking mechanism.

6. The scooter-type vehicle according to claim 1, wherein the vehicle is equipped with a disc-type braking mechanism.

7. The scooter-type vehicle according to claim 1, wherein the vehicle is equipped with a drum-type braking mechanism.

8. The scooter-type vehicle according to claim 1, wherein the vehicle is equipped with 2 additional caster wheels in the front and rear for added stability.

9. The scooter-type vehicle according to claim 1, wherein the vehicle is equipped with solid rubber tires.

10. The scooter-type vehicle according to claim 1, wherein the vehicle is equipped with pneumatic tires.
